(19) United States
(12) Patent Application Publication
(10) Pub. No.: US 2021/0114690 A1
(43) Pub. Date: Apr. 22, 2021

(54) DRIVE TRACK FOR A TRACKED VEHICLE

(71) Applicant: BOMBARDIER RECREATIONAL PRODUCTS INC., Valcourt (CA)

(72) Inventors: Jean-Sebastien PARD, Tingwick (CA); Max RICHER, Valcourt (CA)

(21) Appl. No.: 16/759,976

(22) PCT Filed: Feb. 19, 2018
(86) PCT No.: PCT/IB2018/051014

§ 371 Date: Apr. 28, 2020

Related U.S. Application Data
(60) Provisional application No. 62/579,500, filed on Oct. 31, 2017.

(51) Int. Cl. B62M 27/02; B62D 55/07

(52) U.S. Cl. CPC B62M 27/02; B62D 55/24; B62D 55/07

(57) ABSTRACT

A drive track for a tracked vehicle has an endless belt having an outer surface and an inner surface opposite the outer surface, a plurality of lugs projecting from the outer surface, a plurality of stiffening rods extending laterally in the endless belt, and a plurality of rib segments disposed on the outer surface of the endless belt. The plurality of rib segments extends in a longitudinal direction around an entirety of the endless belt. The rib segments are laterally aligned with each other. Each rib segment of the plurality of rib segment has a height and a width. The height is greater than the width. At least some longitudinally consecutive rib segments of the plurality of rib segments are connected to each other by a corresponding lug of the plurality of lugs disposed longitudinally between the longitudinally consecutive of rib segments. A vehicle with drive track is also described.

### CROSS-REFERENCE

The present application claims priority to U.S. Provisional Application No. 62/579,500, filed Oct. 31, 2017, the entirety of which is incorporated herein by reference.

### FIELD OF TECHNOLOGY

The present technology relates to drive tracks for tracked vehicles.

### BACKGROUND

Some vehicles, such as snowmobiles, are provided with endless drive tracks to enable travel over soft surfaces that would be difficult to travel over with wheels, such as snow and mud. The endless drive track is driven by the vehicle's engine via one or more sprockets that engage the endless drive track to turn the drive track and thereby propel the vehicle. Some drive tracks, such as those of snowmobiles, are made of rubber and have an endless belt with a plurality of lugs projecting from an outer surface thereof.

In order to accelerate the drive track, the engine has to overcome the inertia of the drive track. Similarly, in order to decelerate the drive track, the braking system has to overcome the inertia of the drive track. The heavier the drive track is, the more inertia needs to be overcome by the engine and braking system. Also, in order to travel over soft snow, a snowmobile, including its drive track, should be relatively light. One solution for having a lightweight drive track is to make the endless belt thin.

Some rubber drive tracks have rows of lateral stiffening rods embedded in the rubber to increase the lateral bending strength of the drive track. This makes the drive track stiff in the lateral direction while the track remains flexible in the longitudinal direction, which is needed for the drive track to easily rotate around the front drive sprocket and the rear idler wheels over which the drive track is provided.

However, in some cases, a thin and lightweight track with stiffening rods creates vibration and noise when the idler wheels pass over the stiffening rods.

It would be desirable to reduce the noise and vibrations generated by the passage of idler wheels over the stiffening rods in drive tracks.

### SUMMARY

It is an object of the present technology to ameliorate at least some of the inconveniences described above.

According to one aspect of the present technology, there is provided a drive track for a tracked vehicle having: an endless belt having an outer surface and an inner surface opposite the outer surface; a plurality of lugs projecting from the outer surface; a plurality of stiffening rods extending laterally in the endless belt; and a plurality of rib segments disposed on the outer surface of the endless belt. The plurality of rib segments extend in a longitudinal direction around an entirety of the endless belt. The rib segments of the plurality of rib segments are laterally aligned with each other. Each rib segment of the plurality of rib segment has a height and a width. The height is greater than the width. At least some longitudinally consecutive rib segments of the plurality of rib segments are connected to each other by a corresponding lug of the plurality of lugs disposed longitudinally between the longitudinally consecutive of rib segments.

In some embodiments of the present technology, the height of each rib segment of the plurality of rib segments is less than a height of the plurality of lugs.

In some embodiments of the present technology, the height of each rib segment of the plurality of rib segments is constant.

In some embodiments of the present technology, the height of each rib segment of the plurality of rib segments is variable.

In some embodiments of the present technology, the plurality of rib segments has a generally sinusoidal profile as viewed from a lateral direction.

In some embodiments of the present technology, each rib segment of the plurality of rib segments has a generally concave profile as viewed from a lateral direction.

In some embodiments of the present technology, the endless belt has a plurality of windows defined in the longitudinal direction; and the plurality of rib segments is disposed laterally between at least two windows of the plurality of windows.

In some embodiments of the present technology, the plurality of rib segments is a plurality of plurality of rib segments.

In some embodiments of the present technology, the plurality of plurality of rib segments comprises a first plurality of rib segments, a second plurality of rib segments, a third plurality of rib segments, a fourth plurality of rib segments, and a fifth plurality of rib segments.

In some embodiments of the present technology, the endless belt has a first and a second lateral side; the endless belt has a first row of windows and a second row of windows defined in the longitudinal direction; the first plurality of rib segments is disposed laterally between the first row of windows and the first lateral side; the second plurality of rib segments is disposed laterally between the first row of windows and the third plurality of rib segments; the third plurality of rib segments is laterally centered; the fourth plurality of rib segments is disposed laterally between the second row of windows and the third plurality of rib segments; and the fifth plurality of rib segments is disposed laterally between the second row of windows and the second lateral side.

In some embodiments of the present technology, at least one internal band is disposed on an inner surface of the endless belt and extending in a longitudinal direction around then entirety of the endless belt. The at least one internal band is laterally aligned with at least one plurality of rib segments of the plurality of plurality of rib segments.

In some embodiments of the present technology, a hardness of the plurality of lugs, a hardness of the plurality of plurality of rib segments, and a hardness of the at least one band are less than a hardness of a layer of the endless belt, the layer of the endless belt including the inner surface of the endless belt.

In some embodiments of the present technology, each rib segment of the plurality of rib segments is made from rubber.

In some embodiments of the present technology, each rib segment of the plurality of rib segments is made from rubber reinforced with fabric.

In some embodiments of the present technology, a plurality of cleats is attached to the endless belt.

In some embodiments of the present technology, at least one rib segment of the plurality of rib segments passes over at least one stiffening rod of the plurality of stiffening rods.

In some embodiments of the present technology, all longitudinally consecutive rib segments of the plurality of rib segments are connected to each other by the corresponding lug of the plurality of lugs disposed longitudinally between the longitudinally consecutive of rib segments.

In some embodiments of the present technology, the lugs connecting consecutive rib segments define apertures in an end thereof for receiving studs therein.

In some embodiments of the present technology, the plurality of rib segments is a first plurality of plurality of rib segments and a second plurality of rib segments; the endless belt has a first and a second lateral side; the endless belt has a first row of windows and a second row of windows defined in the longitudinal direction; the first plurality of rib segments is disposed laterally between the first row of windows and the first lateral side; and the second plurality of rib segments is disposed laterally between the second row of windows and the second lateral side.

According to another aspect of the present technology, there is provided a vehicle having: a frame; a motor supported by the frame; and the drive track according to any one of the above embodiments operatively connected to the motor.

In some embodiments of the present technology, the vehicle is a snowmobile; the frame has a tunnel; the drive track is disposed at least in part under the tunnel. The snowmobile also has at least one ski operatively connected to the frame.

In some embodiments of the present technology, a rear suspension assembly is connected to the frame. The rear suspension assembly includes at least one idler wheel. The plurality of rib segments is laterally aligned with the at least one idler wheel.

In some embodiments of the present technology, the drive track also has at least one internal band disposed on an inner surface of the endless belt and extending in a longitudinal direction around then entirety of the endless belt. The at least one internal band is laterally aligned with the at least one idler wheel. A width of the at least one internal band is greater than or equal to a width of an outer surface of the at least one idler wheel.

In some embodiments of the present technology, a rear suspension assembly is connected to the frame. The rear suspension assembly includes at least one slide rail. The at least one slide rail is disposed laterally between the plurality of rib segments and a lateral center of the endless belt.

For purposes of the present application, terms related to spatial orientation when referring to a snowmobile and components in relation to the snowmobile, such as “forwardly”, “rearward”, “left”, “right”, “above” and “below”, are as they would be understood by a driver of the snowmobile, with the snowmobile in a straight ahead orientation (i.e. not steered left or right), and in an upright position (i.e. not tilted). When referring to a drive track of the snowmobile alone, terms related to spatial orientation, such as “lateral” and “longitudinal” should be taken with respect to the drive track itself.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of a snowmobile and a rider thereupon;

FIG. 2 is a bottom view of a rear suspension assembly including a portion of a drive track of the snowmobile of FIG. 1;

FIG. 3 is cross-sectional view taken through line 3-3 of FIG. 2;

FIG. 4 is a top perspective view of a portion of the drive track of FIG. 2;

FIG. 5 is a front view of the portion of the drive track of FIG. 4;

FIG. 6 is a side view of the portion of the drive track of FIG. 4;

FIG. 7 is a top perspective view of an alternative embodiment of the portion of the drive track of FIG. 4;

FIG. 8 is a top perspective view of another alternative embodiment of the portion of the drive track of FIG. 4;

FIG. 9 is a top perspective view of another alternative embodiment of the portion of the drive track of FIG. 4;

FIG. 10 is a top perspective close-up view of a portion of the drive track of FIG. 9 showing an external lug connecting two consecutive rib segments; and

FIG. 11 is a front cross-sectional view of the portion of the drive track of FIG. 9.

### DETAILED DESCRIPTION

Embodiments of a drive track will be described herein in combination with a snowmobile 10. It is contemplated that the embodiments of the drive track or some aspects thereof could be used on drive tracks of other tracked vehicles, such as all-terrain vehicles (ATVs), utility task vehicles (UTVs) or agricultural machinery equipped with tracks.

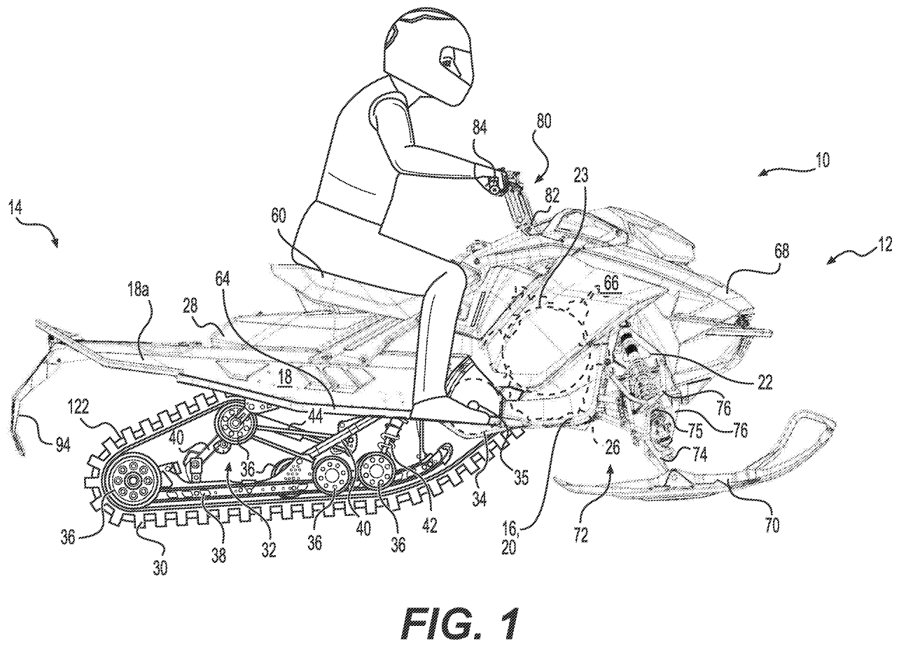

With reference to FIG. 1, a snowmobile 10 includes a front end 12 and a rear end 14 which are defined consistently with a travel direction of the snowmobile 10. The snowmobile 10 has a frame 16. The frame 16 includes a tunnel 18, an engine module 20, a front suspension module 22 and an upper structure (not shown). The tunnel 18 is formed from sheet metal parts assembled to form an inverted U-shape when viewed from the front or rear end 12, 14. The tunnel 18 has a left side portion 18a and a right side portion 18a (only the right being shown).

A motor 26, schematically illustrated in FIG. 1, is carried in an engine compartment defined by the engine module 20 of the vehicle body 16 and provides, in part, propulsion of the snowmobile 10. In the illustrated embodiment, the motor 26 is an internal combustion engine, but it is contemplated that it could be, for example, an electric motor or a hybrid. A fuel tank 28, supported above the tunnel 18, supplies fuel to the motor 26 for its operation.

An endless drive track 30 is positioned generally under the tunnel 18, and is operatively connected to the motor 26 via a drivetrain including a transmission system 23 (shown schematically). The endless drive track 30 is driven to run about a rear suspension assembly 32 connected to the vehicle body 16 for propulsion of the snowmobile 10.

The rear suspension assembly 32 includes a pair of drive sprockets 34 (shown schematically) mounted on a drive axle 35 (shown schematically), idler wheels 36 and a pair of slide rails 38 in sliding contact with the endless drive track 30. The drive axle 35 has the drive sprockets 34 mounted thereon and defines a drive axle axis. As can be seen in FIG. 1 the slide rails 38 are attached to the tunnel 18 by front and rear suspension arms 40 and a shock absorber and coil spring assembly 42. A shock absorber 44 is connected between the two suspension arms 40. The rear suspension assembly 32 has other features and components which will not be described herein. It is contemplated that the snowmobile 10 could be provided with a different embodiment of a rear suspension assembly.

Returning to FIG. 1, a straddle seat 60 is positioned atop the fuel tank 28. The seat 60 is adapted to accommodate a driver of the snowmobile 10, as shown in FIG. 1. It is contemplated that the seat 60 could also be configured to accommodate one or more passengers. It is also contemplated that the snowmobile 10 could include an additional one or more seats for passengers. A footrest 64 is positioned on each side of the snowmobile 10 below the seat 60 to accommodate the driver's feet. Each of the left and right footrests 64 extends generally laterally outwardly from the corresponding left and right side portion 18a of the tunnel 18. In the illustrated embodiment, each left and right side portion 18a of the tunnel 18 is bent laterally outwardly at its bottom edge to form the corresponding footrest 64. It is however contemplated that the footrests 64 could be formed separately from and mounted to the tunnel 18.

At the front end 12 of the snowmobile 10, fairings 66 enclose the motor 26, the transmission system 23 and other components of the power pack such as the air intake system. The fairings 66 include a hood 68. The motor 26 and the transmission system 23 are disposed between right and left side fairings 66.

Two skis 70 are positioned at the front of the snowmobile 10. Each of the two skis 70 is attached to the front suspension module 22 of the vehicle body 16 through corresponding front suspension assembly 72. Each front suspension assembly 72 includes a ski leg 74, a shock absorber assembly 75, supporting arms 76 and ball joints (not labeled).

A steering assembly 80, including a steering column 82 and a handlebar 84, is provided forward of the seat 60. The steering column 82 is rotatably connected to the frame 16. The handlebar 84 is connected to the upper end of the steering column 82. The handlebar 84 is used to rotate the steering column 82, and thereby the two skis 70, in order to steer the snowmobile 10.

At the rear end of the snowmobile 10, a snow flap 94 extends downward from the rear end of the tunnel 18. The snow flap 94 deflects snow and ice projected upward and rearward from the endless drive track 30 when the snowmobile 10 is being driven.

The snowmobile 10 includes other components such as a display cluster, an exhaust system, an air intake system, and the like. As it is believed that these components would be readily recognized by one of ordinary skill in the art, further explanation and description of these components will not be provided herein.

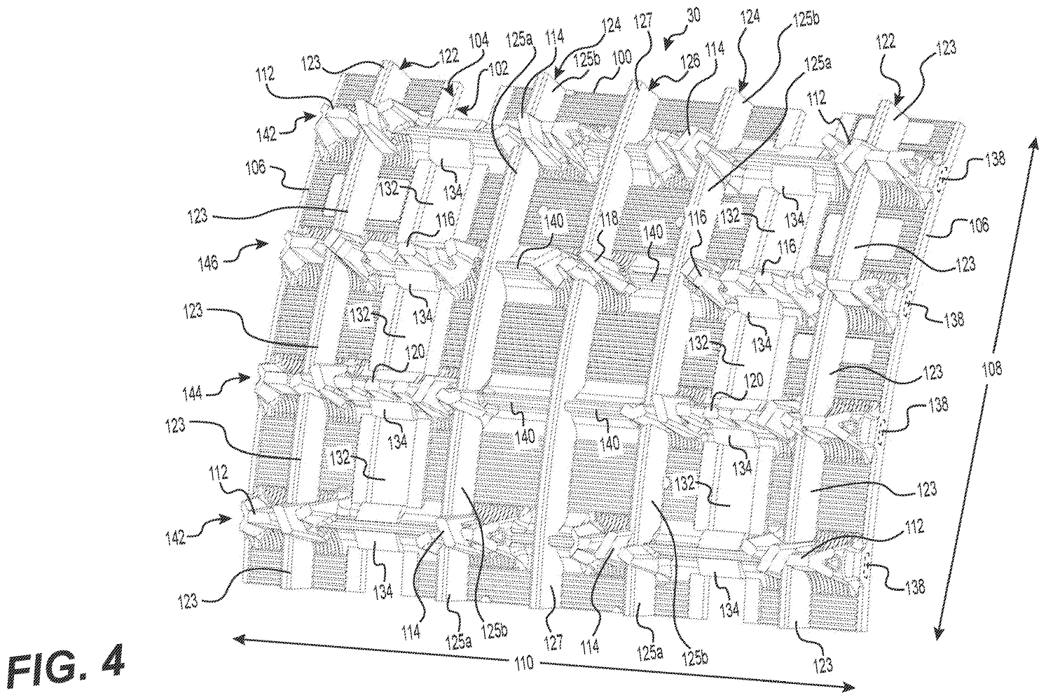

Turning now to FIGS. 4 to 6, the endless drive track 30 will be described in more detail. The endless drive track 30 has an endless belt 100 which has an inner surface 102, an outer surface 104 and lateral edges 106. The endless drive track 30 defines a longitudinal direction 108 and a lateral direction 110. In the description of the endless drive track 30 below, the terms “longitudinal” and “lateral” are used with respect to the respective directions as defined by the endless drive track 30.

The endless drive track 30 includes a plurality of external lugs 112, 114, 116, 118, and 120 that project outwardly from the outer surface 104. The plurality of external lugs 112, 114, 116, 118, and 120 provide the endless drive track 30 with traction as the endless drive track 30 propels the snowmobile 10.

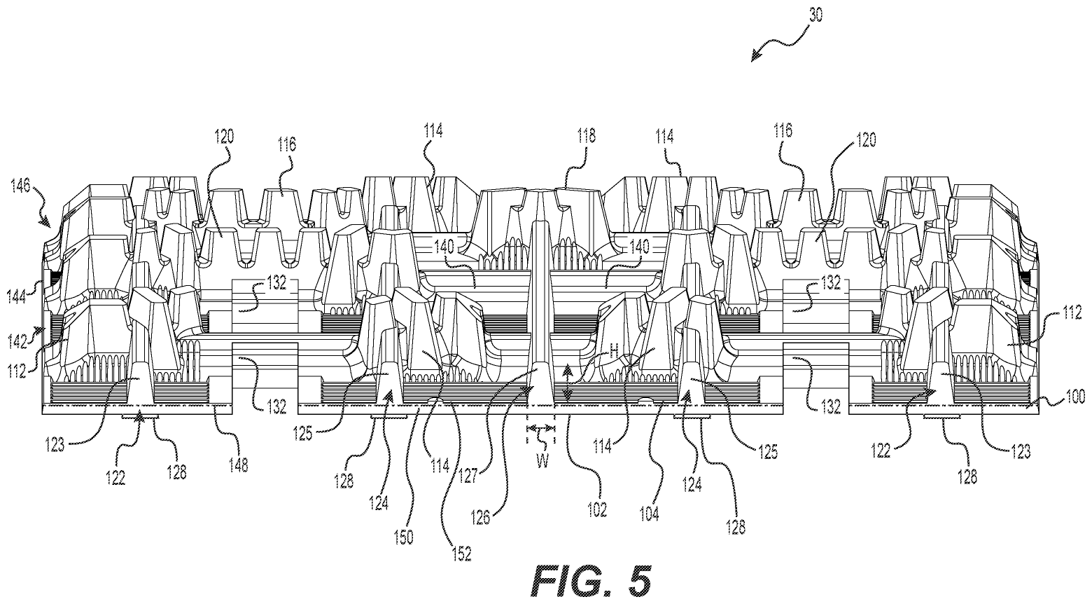

As best seen in FIGS. 4 and 5, the external lugs 112, 114, 116, 118, and 120 are arranged in a pattern of three lateral rows. This first row 142 of the pattern contains two external lugs 112 along the lateral edges 106 and two external lugs 114 laterally between the two external lugs 112. The second row 144 (i.e. the middle row) of the pattern contains two external lugs 120 along the lateral edges 106. The third row 146 of the pattern contains two external lugs 116 along the lateral edges 106 and one laterally centered external lug 118. This pattern of three lateral rows is repeated in the longitudinal direction 108 along the entire periphery of the endless belt 100.

The external lugs 112, 114, 116, and 120 disposed on a left side of the endless drive track 30 are a mirror image of the external lugs 112, 114, 116, and 120 on the right side of the endless drive track 30. The external lugs 118 are symmetric about the center of the endless drive track 30.

It is contemplated that the endless drive track 30 could have more or less external lugs, that the external lugs could be different from the ones illustrated in the figures, and/or that the external lugs could be arranged in a pattern different from the one illustrated in the figures.

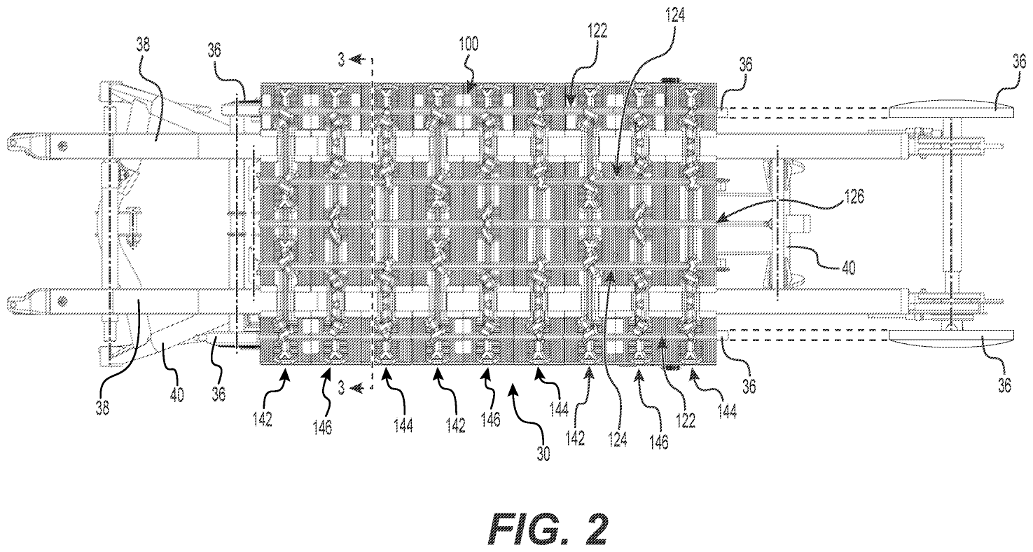

The endless drive track 30 also includes a plurality of longitudinal rows 122, 124, and 126 of rib segments 123, 125, 127, respectively, that project outwardly from the outer surface 104 of the flexible belt 100 and extend in the longitudinal direction 108 around the flexible belt 100. As can be seen in FIGS. 2 to 5, the plurality of rows include laterally outer left and right rows 122, intermediate left and right rows 124, and a middle row 126. The rib segments 123, 125, 127 forming each of the rows 122, 124, 126 are laterally aligned with each other. The plurality of rib segments 123, 125, and 127 increase the stiffness of the endless drive track 30 in the longitudinal direction 108. The plurality of rows 122, 124 and 126 will be described in more detail below.

It is contemplated that in an alternative embodiment, the endless drive track 30 could have a plurality of internal lugs that project inwardly from the inner surface 102 to be engaged by axial teeth of an alternative embodiment of the drive sprockets 34 so as to move the endless belt 100 around the rear suspension assembly 32.

Left and right rows of longitudinally spaced windows 132 are defined in the endless belt 100. Each window 132 extends through the endless belt 100. The left and right rows of longitudinally spaced windows 132 are defined respectively at the left and the right of the lateral center of the endless belt 100. The slide rails 38 are laterally aligned with the rows of longitudinally spaced windows 132. It is contemplated that the longitudinally spaced windows 132 could form only one longitudinal row or more than two longitudinal rows. The windows 132 are engaged by the radial sprocket teeth (not shown) of the drive sprockets 34 for moving the endless belt 100. As can be seen in FIGS. 4 and 5, the external lugs 116 are disposed between longitudinally consecutive windows 132 Similarly, the external lugs 120 are disposed between longitudinally consecutive windows 132. It is contemplated that the rows of longitudinally spaced windows 132 could be omitted, and other methods of driving the endless drive track 30 could be used.

Cleats 134 are connected to the portions of the endless belt 100 disposed between adjacent windows 132. The cleats 134 extend over the inner surface 102 of these portions of the endless belt 100 and provide a surface over which the slide rails 38 slide. It is contemplated that the cleats 134 could be omitted.

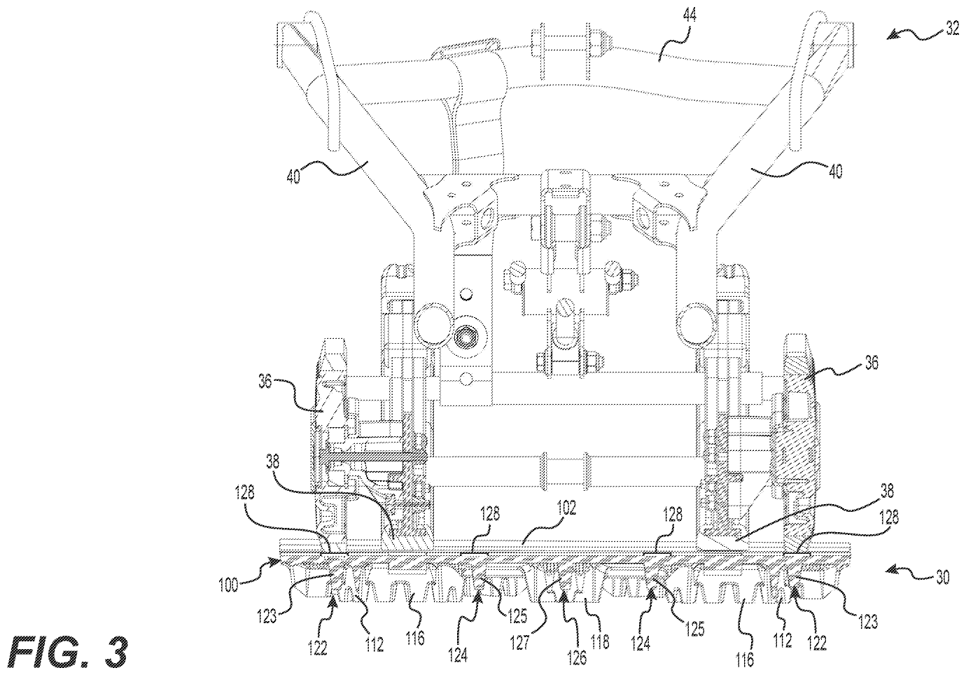

As best seen in FIG. 5, the endless drive track 30 also includes internal bands 128 extending in the longitudinal direction 108. The internal bands 128 extend in the longitudinal 108 direction along the inner surface 102 and provide a surface along which the idler wheels 36 can roll. As can be seen in FIG. 3, the internal bands 128 are wider than the outer surface of the idler wheels 36 (i.e. the rolling surface). It is contemplated that the internal bands 128 could be as wide as the outer surface of the idler wheels 36. It is contemplated that the internal bands 128 could be omitted such that the idler wheels 36 would roll directly on the inner surface 102 of the endless belt 102.

The laterally outer left and right longitudinal rows 122 of rib segments 123 are each disposed near the lateral edges 106 of the endless belt 100. More specifically, the outer left row 122 is laterally between the left lateral edge 106 and the left row of longitudinally spaced windows 132 and the outer right row 122 is laterally between the right lateral edge 106 and the right row of longitudinally spaced windows 132. As can be seen in FIGS. 2 and 3, the outer left and right rows 122 of rib segments 123 are laterally aligned with the laterally outer idler wheels 36 and the corresponding inner bands 128. It is contemplated that the outer left and right rows 122 of rib segments 123 could not be laterally centered relative to the laterally outer idler wheels 36, but that a portion the base of the rib segments 123 could be laterally aligned with their respective laterally outer idler wheels 36. The middle row 126 of rib segments 127 is centered laterally on the endless belt 100. The intermediate left row 124 of rib segments 125 is disposed laterally between the left row of longitudinally spaced windows 132 and the middle row 126 of rib segments 127. The intermediate right row 124 of rib segments 125 is disposed laterally between the right row of longitudinally spaced windows 132 and the middle rib 126. It is contemplated that the endless drive track 30 could have only one, two, three, four or more than five rows of rib segments. For example, it is contemplated that the endless track 30 could have only the laterally outer left and right longitudinal rows 122 of rib segments 123.

With reference to FIG. 5, each of the plurality of rib segments 123, 125, and 127 has a height H that is greater than its width W. The height H is measured in a direction normal to the outer surface 104 of the endless belt 100 from the outer surface 104 to the tip of the corresponding rib segment 123, 125 or 127. In the present embodiment, the height H is constant over the length of each rib segment 123, 125, 127. The width W is measured in the lateral direction 110 at the widest portion of the corresponding rib segment 123, 125 or 127. In the present embodiment, since the rib segments 123, 125, 127 taper from their bases to their tips, the width W is measured at the base of the rib segments 123, 125, 127 (i.e. where the rib segments 123, 125, 127 intersect the outer surface 104). In the present embodiment, all of the rib segments 123, 125, 127 have the same height H and the same width W. It is contemplated that different rib segments 123, 125, 127 could have different heights H and widths W. As can be seen, the height H of the plurality of rib segments 123, 125 and 127 is less than the height of the external lugs 112, 114, 116, 118, 120.

As can be seen in FIG. 4, the rows 122 are made up of rib segments 123 having substantially the same length. The rows 124 are made up of long rib segments 125a and short rib segments 125b that alternate in a longitudinal direction around an entirety of the endless belt 100. The row 126 is made up of rib segments 127 having substantially the same length. The rib segments 123 and 125b have substantially the same length. The rib segments 125a are longer than the rib segments 123 and 125b. The rib segments 127 are the longest rib segments of the rib segments 123, 125a, 125b, 127.

As best seen in FIGS. 4 and 5, each of the external lugs 112, 116 and 120 on the left and right side of the endless drive track 30 is disposed longitudinally between two consecutive rib segments 123 of the outer left and right rows 122 and connects these two rib segments 123 to each other. Each of the external lugs 114 and 120 on the left and right side of the endless drive track 30 is disposed longitudinally between two consecutive rib segments 125 (i.e. one rib segment 125a and one rib segment 125b) of the intermediate left and right rows 124 and connects these two rib segments 125 to each other. Each of the external lugs 118 is disposed longitudinally between two consecutive rib segments 127 of the middle row 126 and connects these two rib segments 127 to each other. The specific length and shape of each of the rib segments 123, 125a, 125b and 127 is dictated by the shape and position of the external lugs 112, 114, 116, 118, 120 that the rows 122, 124, 126 of rib segments 123, 125, 127 intersect. As such, for an alternative embodiment of a drive track having the same length and width as the drive track 30, having five rows of rib segments in the same lateral positions as the rows 122, 124, 126 of the drive track 30, but having a different pattern of external lugs, the specific length and shape of the various rib segments making up the five rows of rib segments would differ from that of the drive track 30 and would be dictated by the shape and position of the external lugs that the rows of rib segments intersect. As the pattern of external lugs repeats longitudinally around a drive track, the pattern of rib segments also repeats longitudinally around the drive track.

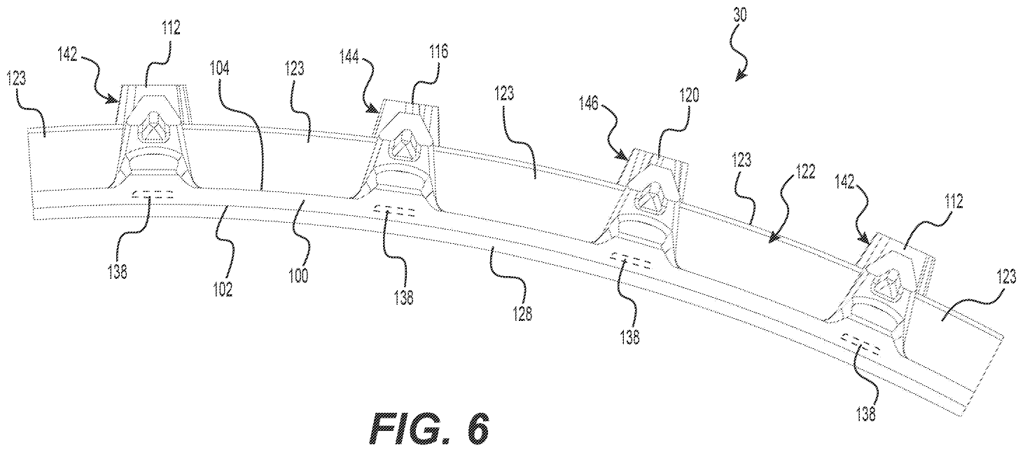

Stiffening rods 138 (shown schematically in FIG. 6) extend laterally inside the endless belt 100 between the inner and outer surfaces 102, 104. One stiffening rod 138 is provided in alignment with each laterally extending row 142, 144, 146 of external lugs 112, 114, 116, 118 and 120. It is contemplated that not every laterally extending row 142, 144, 146 of external lugs 112, 114, 116, 118 and 120 could be provided with stiffening rod 138. The stiffening rods 138 are D-shaped, but other shapes of stiffening rods are contemplated. The stiffening rods 138 are fiberglass rods, but it is contemplated that other materials could be used, such as carbon fiber or metal for example. The endless drive track 30 has laterally extending ridges 140 along the outer surface 104 thereof formed by the stiffening rods 138. The plurality of rows 122, 124 and 126 of rib segments 123, 125, 127 are perpendicular to the stiffening rods 138. As can be seen in FIG. 4 for one left rib segment 125a and one right rib segment 125a, the rib segments 125a pass over the stiffening rods 138 aligned with the laterally extending rows 146 of external lugs 116, 118. As can also be seen in FIG. 4, the rib segments 127 pass over the stiffening rods 138 aligned with the laterally extending rows 142, 144 of external lugs 112, 114, 120.

The endless drive track 30 is made of a strong, flexible material such as rubber. In some embodiments, the rubber in the endless belt 100 is reinforced with layers of fabric and/or string, but the external lugs 112, 114, 116, 118 and 120 and the rib segments 123, 125 and 127 are not reinforced. In some embodiments, the rib segments 123, 125 and 127 are reinforced with layers of fabric and/or string. The endless belt 100, the external lugs 112, 114, 116, 118 and 120 and the rib segments 123, 125 and 127 are integrally formed with each other.

In the embodiment illustrated in FIG. 5, the endless belt 100 is reinforced with a layer of fabric 148 (shown in dash-dot lines). The portion 150 of the endless belt 100 located between the layer of fabric 148 and the inner surface 102 of the endless belt 100 is made from a harder rubber than the portion 152 of the endless belt 100 located between the layer of fabric 148 and the outer surface 102. The portion 150 of the endless belt 100 is also made from a harder rubber than the external lugs 112, 114, 116, 118, 120, the rib segments 123, 125, 128, the internal bands 128 and the ridges 140. In one embodiment, the portion 150 of the endless belt 100 is made from a rubber having a Shore A hardness of 80 durometer and the portion 152 of the endless belt 100, the external lugs 112, 114, 116, 118, 120, the rib segments 123, 125, 128, the internal bands 128 and the ridges 140 are made from a rubber having a Shore A hardness of 60 durometer. In an alternative embodiment in which the endless drive track 30 is additionally provided with internal lugs, the internal lugs have the same hardness as the portion 150 of the endless belt 100. It is contemplated that the endless drive track 30 could be made from a single type of rubber, thus having the same hardness everywhere, or from rubbers having more than two different hardness values.

The rib segments 123, 125 and 127 increases the stiffness of the endless drive track 30 in the longitudinal direction 108 of the endless drive track 30. The increased longitudinal stiffness results in less noise and vibration when the idler wheels 38 roll over the stiffening rods 138.

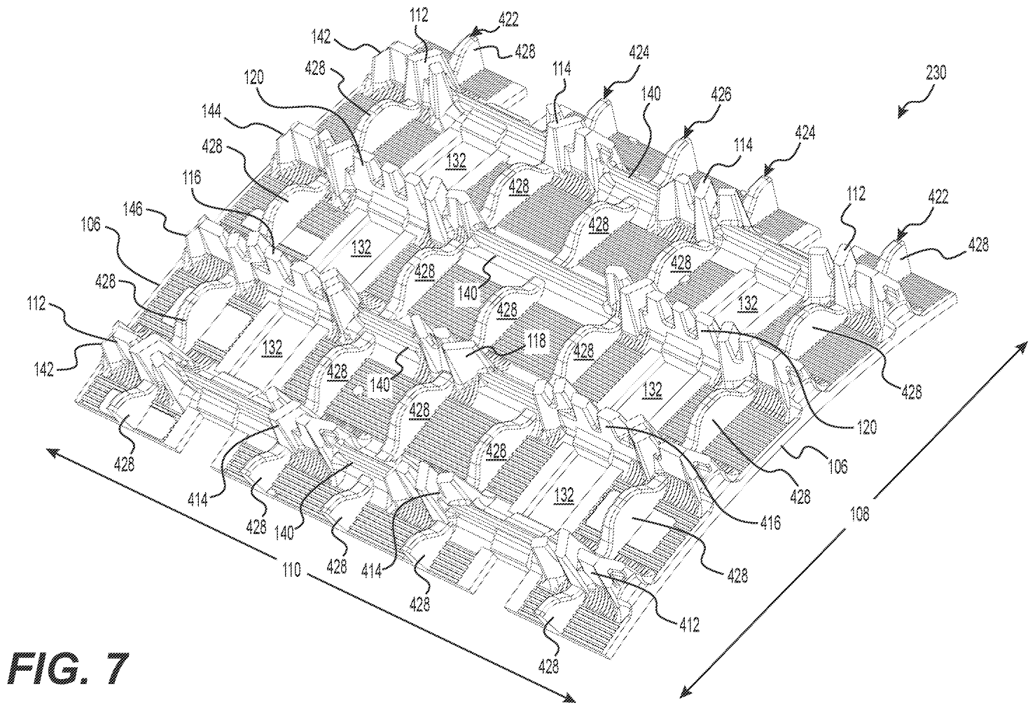

Turning now to FIG. 7, a track 230 which is an alternative embodiment of the endless drive track 30 will be described. For simplicity, elements of the track 230 that are similar to those of the endless drive track 30 described above have been labeled with the same reference numerals in the Figures and will not be described again.

In the track 230, the plurality of rows 122, 124 and 126 of rib segments 123, 125, 127 have been replaced by a plurality of rows 422, 424, and 426 of rib segments 428 that project outwardly from the outer surface 104 and extend in the longitudinal direction 108. The rib segments 428 forming each of the rows 422, 424, 426 are laterally aligned with each other. The plurality of rows 422, 424, and 426 comprises laterally outer left and right rows 422, intermediate left and right rows 424, and a middle row 426. The laterally outer left and right rows 422 are each disposed near the lateral edges 106 of the endless belt 100. More specifically, the outer left row 422 is laterally between the left lateral edge 106 and the left row of longitudinally spaced windows 132 and the outer right row 422 is laterally between the right lateral edge 106 and the right row of longitudinally spaced windows 132. The intermediate left and right rows 424 are laterally aligned with the idler wheels 36 located between the slide rails 38. The outer left and right rows 422 are also laterally aligned with some of the idler wheels 36. The middle row 426 is centered laterally on the endless belt 100. The intermediate left row 424 is disposed laterally between the left row of longitudinally spaced windows 132 and the middle row 426. The intermediate right row 424 is disposed laterally between the right row of longitudinally spaced windows 132 and the middle row 426. It is contemplated that the drive track 230 could have only one, two, three, four or more than five rows of rib segments 528.

In the embodiment depicted in FIG. 7, the rib segments 428 are substantially the same and each rib segment 428 has a variable height. Each of the rib segment 428 is relatively short near its longitudinal ends and increases in height toward its longitudinal center. As a result, the rib segments 428 give each of the plurality of rows 422, 424, and 426 a generally sinusoidal profile as seen from the lateral side of the drive track 230. The crests of each of the plurality of rows 422, 424, and 426 is located between two lateral rows 142, 144, 146 of external lugs 112, 114, 116, 118 and 120 and the troughs are located at the lateral rows 142, 144, 146 of external lugs 112, 114, 116, 118 and 120.

Each of the external lugs 112, 116 and 120 on the left and right side of the endless drive track 230 is disposed longitudinally between two consecutive rib segments 428 of the outer left and right rows 422 and connects these two rib segments 428 to each other. Each of the external lugs 114 and 120 on the left and right side of the endless drive track 230 is disposed longitudinally between two consecutive rib segments 428 of the intermediate left and right rows 424 and connects these two rib segments 428 to each other. The laterally extending ridges 140 in alignment with the rows 146 of external lugs 116, 118 are each disposed longitudinally between two consecutive rib segments 428 of the rows 424 and connects these two rib segments 428 to each other. Each of the external lugs 118 is disposed longitudinally between two consecutive rib segments 428 of the middle row 426 and connects these two rib segments 428 to each other. The laterally extending ridges 140 in alignment with the rows 142, 144 of external lugs 112, 114, 120 are each disposed longitudinally between two consecutive rib segments 428 of the row 426 and connects these two rib segments 428 to each other.

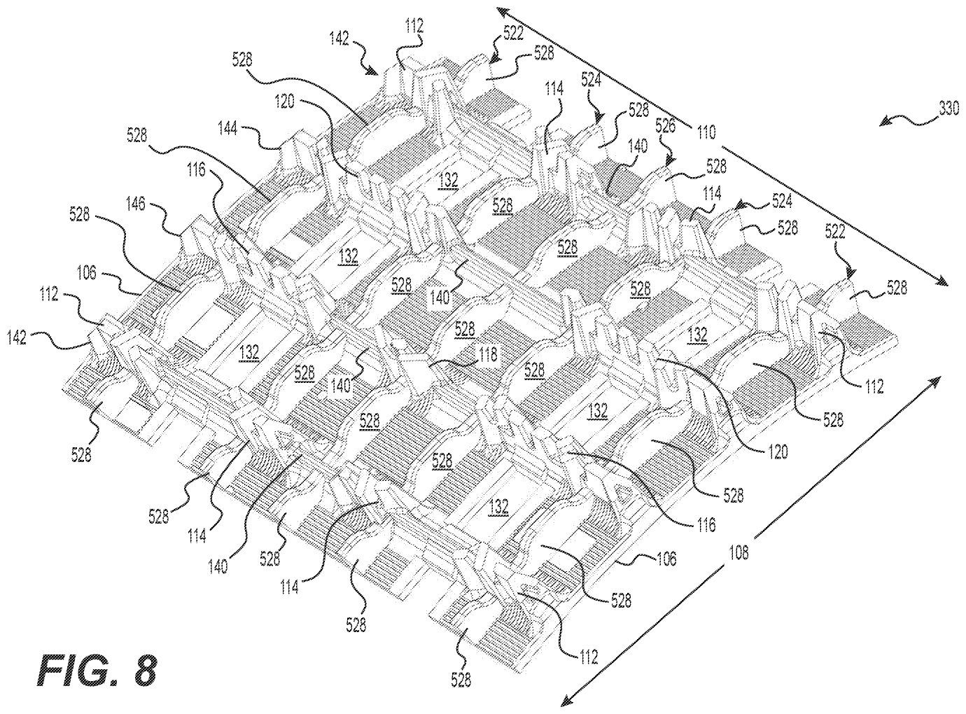

Turning now to FIG. 8, a track 330 which is an alternative embodiment of the endless drive track 30 will be described. For simplicity, elements of the track 330 that are similar to those of the endless drive track 30 described above have been labeled with the same reference numerals in the Figures and will not be described again.

In the track 330, the plurality of rows 122, 124, and 126 of rib segments 123, 125, 127 have been replaced by the plurality of rows 522, 524, and 526 of rib segments 528 that project outwardly from the outer surface 104 and extend in the longitudinal direction 108. The rib segments 528 forming each of the rows 522, 524, 526 are laterally aligned with each other. The plurality of rows 522, 524, and 526 comprises laterally outer left and right rows 522, intermediate left and right rows 524, and a middle row 526. The laterally outer left and right rows 522 are each disposed near the lateral edges 106 of the endless belt 100. More specifically, the outer left row 522 is laterally between the left lateral edge 106 and the left row of longitudinally spaced windows 132 and the outer right row 522 is laterally between the right lateral edge 106 and the right row of longitudinally spaced windows 132. The intermediate left and right rows 524 are laterally aligned with the idler wheels 36 located between the slide rails 38. The outer left and right rows 522 are also laterally aligned with some of the idler wheels 36. The middle row 526 is centered laterally on the endless belt 100. The intermediate left row 524 is disposed laterally between the left row of longitudinally spaced windows 132 and the middle rib 526. The intermediate right row 524 is disposed laterally between the right row of longitudinally spaced windows 132 and the middle row 526. It is contemplated that the drive track 330 could have only one, two, three, four or more than five rows of rib segments 528.

In the embodiment depicted in FIG. 8, the rib segments 528 are substantially the same and each rib segment 528 has a variable height. Each of the rib segments 528 has a generally trapezoidal profile.

Each of the external lugs 112, 116 and 120 on the left and right side of the endless drive track 330 is disposed longitudinally between two consecutive rib segments 528 of the outer left and right rows 522 and connects these two rib segments 528 to each other. Each of the external lugs 114 and 120 on the left and right side of the endless drive track 330 is disposed longitudinally between two consecutive rib segments 528 of the intermediate left and right rows 524 and connects these two rib segments 528 to each other. The laterally extending ridges 140 in alignment with the rows 146 of external lugs 116, 118 are each disposed longitudinally between two consecutive rib segments 528 of the rows 524 and connects these two rib segments 528 to each other. Each of the external lugs 118 is disposed longitudinally between two consecutive rib segments 528 of the middle row 526 and connects these two rib segments 528 to each other. The laterally extending ridges 140 in alignment with the rows 142, 144 of external lugs 112, 114, 120 are each disposed longitudinally between two consecutive rib segments 528 of the row 526 and connects these two rib segments 528 to each other.

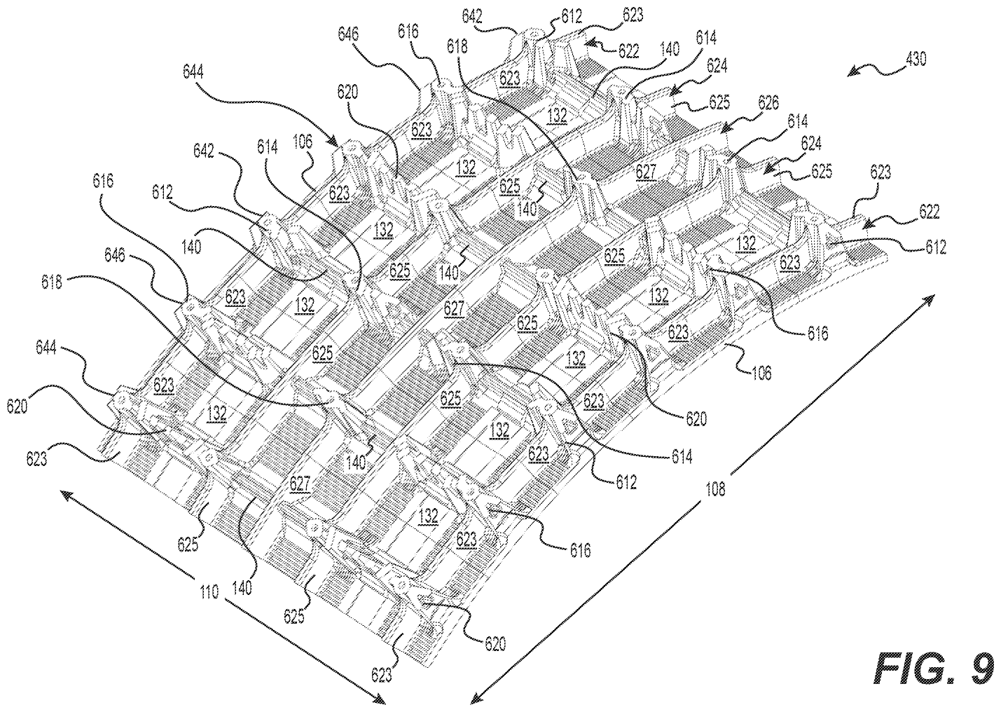

Turning now to FIG. 9, a track 430 which is an alternative embodiment of the endless drive track 30 will be described. For simplicity, elements of the track 430 that are similar to those of the endless drive track 30 described above have been labeled with the same reference numerals in the Figures and will not be described again.

In the track 430, the plurality of longitudinally extending rows 122, 124, and 126 of rib segments 123, 125, 127 have been replaced by the plurality of longitudinally extending rows 622, 624, and 626 of rib segments 623, 625, 627 respectively that project outwardly from the outer surface 104 and extend in the longitudinal direction 108. The laterally extending rows 142, 144, 146 of external lugs 112, 114, 116, 118, and 120 have been replaced by the laterally extending rows 642, 644, 646 of external lugs 612, 614, 616, 618, and 620 respectively that project outwardly from the outer surface 104. The plurality of rows 622, 624, and 626 comprises laterally outer left and right rows 622, intermediate left and right rows 624, and a middle row 626. The laterally outer left and right rows 622 are each disposed near the lateral edges 106 of the endless belt 100. More specifically, the outer left row 622 is laterally between the left lateral edge 106 and the left row of longitudinally spaced windows 132 and the outer right row 622 is laterally between the right lateral edge 106 and the right row of longitudinally spaced windows 132. The intermediate left and right rows 624 are laterally aligned with the idler wheels 36 located between the slide rails 38. The outer left and right rows 622 are also laterally aligned with some of the idler wheels 36. The middle row 626 is centered laterally on the endless belt 100. The intermediate left row 624 is disposed laterally between the left row of longitudinally spaced windows 132 and the middle row 626. The intermediate right row 624 is disposed laterally between the right row of longitudinally spaced windows 132 and the middle row 626. It is contemplated that the drive track 430 could have only one, two, three, four or more than five rows of rib segments.

Each of the plurality of rib segments 623, 625, and 627 has a variable height. The rib segments 623, 625, and 627 are generally concave as viewed from the lateral direction 110. The height of each of the rib segments 623, 625, and 627 is generally constant along its longitudinally central portion but increases at its longitudinal ends. This increase in height at the ends of the rib segments 623, 625, and 627 where they connect with the external lugs 612, 614, 616, 618, and 620 reduces stress concentration points when the endless drive track 30 is in use.

Each of the external lugs 612, 616 and 620 on the left and right side of the endless drive track 430 is disposed longitudinally between two consecutive rib segments 623 of the outer left and right rows 622 and connects these two rib segments 623 to each other. Each of the external lugs 614 and 620 on the left and right side of the endless drive track 430 is disposed longitudinally between two consecutive rib segments 625 of the intermediate left and right rows 624 and connects these two rib segments 625 to each other. Each of the external lugs 618 is disposed longitudinally between two consecutive rib segments 627 of the middle row 626 and connects these two rib segments 627 to each other.

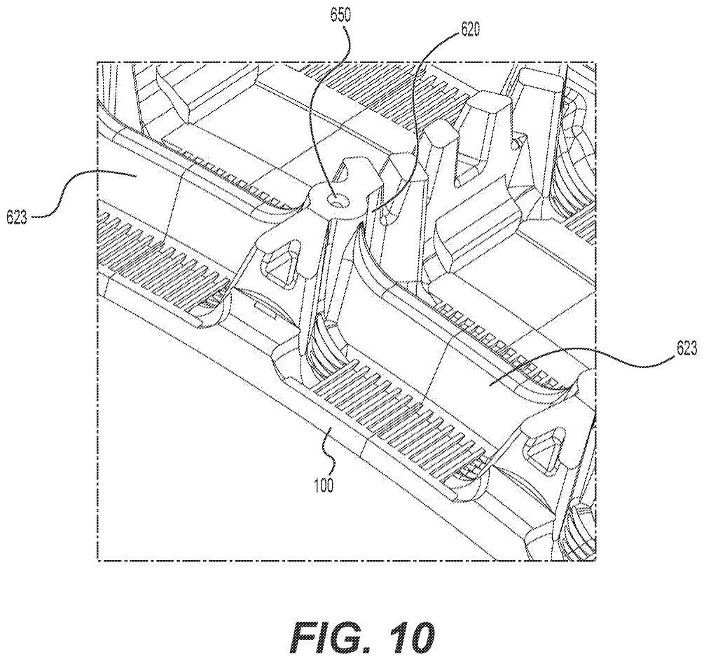

As can be seen in FIG. 10 for one of the external lugs 620, each of the external lugs 620 defines an aperture 650 (only labeled on FIG. 10 for clarity) in an end thereof for receiving a stud therein. This aperture 650 is laterally aligned with its corresponding row 622 of rib segments 623. Each of the external lugs 620 also defines another aperture (similar to aperture 650, but not labeled in FIG. 9 for clarity) in an end thereof closer to a lateral center of the endless track 430 for receiving another stud therein. This other aperture in each external lug 620 is laterally aligned with its corresponding row 624 of rib segments 625. Each of the external lugs 618 defines an aperture (similar to aperture 650, but not labeled in FIG. 9 for clarity) in an end thereof for receiving a stud therein. This aperture in each external lug 618 is laterally aligned with the row 626 of rib segments 627. Each of the external lugs 616 defines an aperture (similar to aperture 650, but not labeled in FIG. 9 for clarity) in an end thereof for receiving a stud therein. This aperture in each external lug 616 is laterally aligned with its corresponding row 622 of rib segments 623. Each of the external lugs 614 defines an aperture (similar to aperture 650, but not labeled in FIG. 9 for clarity) in an end thereof for receiving a stud therein. This aperture in each external lug 614 is laterally aligned with its corresponding row 624 of rib segments 625. Each of the external lugs 612 defines an aperture (similar to aperture 650, but not labeled in FIG. 9 for clarity) in an end thereof for receiving a stud therein. This aperture in each external lug 612 is laterally aligned with its corresponding row 622 of rib segments 623. Studs can be optionally connected to the endless drive track 430 using the apertures in the ends of the external lugs 612, 614, 616, 618, 620 to increase the traction of the endless drive track 430 when operating on hard surfaces such as ice.

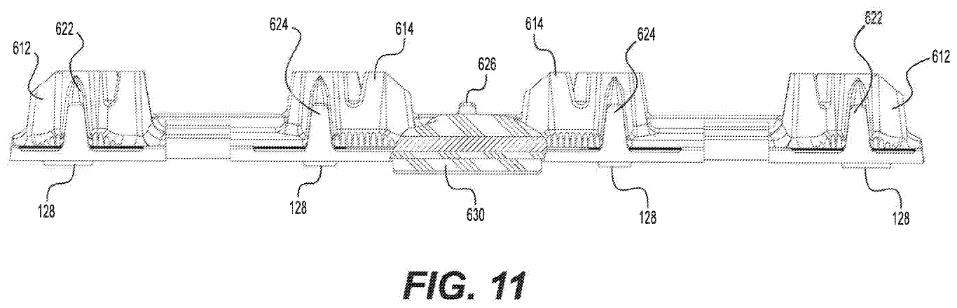

As best seen in FIG. 11, the endless drive track 430 also includes an internal band 630 extending in the longitudinal direction 108. The internal band 630 extends in the longitudinal direction 108 over the inner surface 102 and increase the stiffness of the endless drive track 430. The internal band 630 is made of rubber, and could be reinforced with fabric and/or string.

The drive tracks 30, 130, 230, 330, 430 and the vehicle 10 implemented in accordance with some non-limiting embodiments of the present technology can be represented as follows, presented in numbered clauses.

CLAUSE 1. A drive track for a tracked vehicle comprising: an endless belt having an outer surface and an inner surface opposite the outer surface; a plurality of lugs projecting from the outer surface; a plurality of stiffening rods extending laterally in the endless belt; and a plurality of rib segments disposed on the outer surface of the endless belt, the plurality of rib segments extending in a longitudinal direction around an entirety of the endless belt, the rib segments of the plurality of rib segments being laterally aligned with each other, each rib segment of the plurality of rib segment having a height and a width, the height being greater than the width, at least some longitudinally consecutive rib segments of the plurality of rib segments being connected to each other by a corresponding lug of the plurality of lugs disposed longitudinally between the longitudinally consecutive of rib segments.

CLAUSE 2. The drive track of clause 1, wherein the height of each rib segment of the plurality of rib segments is less than a height of the plurality of lugs.

CLAUSE 3. The drive track of clause 2, wherein the height of each rib segment of the plurality of rib segments is constant.

CLAUSE 4. The drive track of clause 2, wherein the height of each rib segment of the plurality of rib segments is variable.

CLAUSE 5. The drive track of clause 4, wherein the plurality of rib segments has a generally sinusoidal profile as viewed from a lateral direction.

CLAUSE 6. The drive track of clause 4, wherein each rib segment of the plurality of rib segments has a generally concave profile as viewed from a lateral direction.

CLAUSE 7. The drive track of any one of clauses 1 to 6, wherein: the endless belt has a plurality of windows defined in the longitudinal direction; and the plurality of rib segments is disposed laterally between at least two windows of the plurality of windows.

CLAUSE 8. The drive track of any one of clauses 1 to 6, wherein the plurality of rib segments is a plurality of plurality of rib segments.

CLAUSE 9. The drive track of clause 8, wherein: the plurality of plurality of rib segments comprises a first plurality of rib segments, a second plurality of rib segments, a third plurality of rib segments, a fourth plurality of rib segments, and a fifth plurality of rib segments.

CLAUSE 10. The drive track of clause 9, wherein: the endless belt has a first and a second lateral side; the endless belt has a first row of windows and a second row of windows defined in the longitudinal direction; the first plurality of rib segments is disposed laterally between the first row of windows and the first lateral side; the second plurality of rib segments is disposed laterally between the first row of windows and the third plurality of rib segments; the third plurality of rib segments is laterally centered; the fourth plurality of rib segments is disposed laterally between the second row of windows and the third plurality of rib segments; and the fifth plurality of rib segments is disposed laterally between the second row of windows and the second lateral side.

CLAUSE 11. The drive track of any one of clauses 8 to 10, further comprising at least one internal band disposed on an inner surface of the endless belt and extending in a longitudinal direction around then entirety of the endless belt; and wherein the at least one internal band is laterally aligned with at least one plurality of rib segments of the plurality of plurality of rib segments.

CLAUSE 12. The drive track of clause 11, wherein a hardness of the plurality of lugs, a hardness of the plurality of plurality of rib segments, and a hardness of the at least one band are less than a hardness of a layer of the endless belt, the layer of the endless belt including the inner surface of the endless belt.

CLAUSE 13. The drive track of any one of clauses 1 to 12, wherein each rib segment of the plurality of rib segments is made from rubber.

CLAUSE 14. The drive track of any one of clauses 1 to 12, wherein each rib segment of the plurality of rib segments is made from rubber reinforced with fabric.

CLAUSE 15. The drive track of any one of clauses 1 to 14, further comprising a plurality of cleats attached to the endless belt.

CLAUSE 16. The drive track of any one of clauses 1 to 15, wherein at least one rib segment of the plurality of rib segments passes over at least one stiffening rod of the plurality of stiffening rods.

CLAUSE 17. The drive track of any one of clauses 1 to 16, wherein all longitudinally consecutive rib segments of the plurality of rib segments are connected to each other by the corresponding lug of the plurality of lugs disposed longitudinally between the longitudinally consecutive of rib segments.

CLAUSE 18. The drive track of any one of clauses 1 to 17, wherein the lugs connecting consecutive rib segments define apertures in an end thereof for receiving studs therein.

CLAUSE 19. The drive track of any one of clauses 1 to 6, wherein: the plurality of rib segments is a first plurality of plurality of rib segments and a second plurality of rib segments; the endless belt has a first and a second lateral side; the endless belt has a first row of windows and a second row of windows defined in the longitudinal direction; the first plurality of rib segments is disposed laterally between the first row of windows and the first lateral side; and the second plurality of rib segments is disposed laterally between the second row of windows and the second lateral side.

CLAUSE 20. A vehicle comprising: a frame; a motor supported by the frame; and the drive track according to any one of clauses 1 to 19 operatively connected to the motor.

CLAUSE 21. The vehicle of clause 20, wherein: the vehicle is a snowmobile; the frame has a tunnel; the drive track is disposed at least in part under the tunnel; and the snowmobile further comprises at least one ski operatively connected to the frame.

CLAUSE 22. The vehicle of clause 21, further comprising a rear suspension assembly connected to the frame, the rear suspension assembly including at least one idler wheel; and wherein the plurality of rib segments is laterally aligned with the at least one idler wheel.

CLAUSE 23. The vehicle of clause 22, wherein the drive track further comprises at least one internal band disposed on an inner surface of the endless belt and extending in a longitudinal direction around then entirety of the endless belt; wherein the at least one internal band is laterally aligned with the at least one idler wheel; and wherein a width of the at least one internal band is greater than or equal to a width of an outer surface of the at least one idler wheel.

CLAUSE 24. The vehicle of clause 21, further comprising a rear suspension assembly connected to the frame, the rear suspension assembly including at least one slide rail; and wherein the at least one slide rail is disposed laterally between the plurality of rib segments and a lateral center of the endless belt.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A drive track for a tracked vehicle comprising:
an endless belt having an outer surface and an inner surface opposite the outer surface;
a plurality of lugs projecting from the outer surface;
a plurality of stiffening rods extending laterally in the endless belt; and
a plurality of rib segments disposed on the outer surface of the endless belt,
the plurality of rib segments extending in a longitudinal direction around an entirety of the endless belt,
the rib segments of the plurality of rib segments being laterally aligned with each other,
each rib segment of the plurality of rib segment having a height and a width, the height being greater than the width,
at least some longitudinally consecutive rib segments of the plurality of rib segments being connected to each other by a corresponding lug of the plurality of lugs disposed longitudinally between the longitudinally consecutive of rib segments.

2. The drive track of claim 1, wherein the height of each rib segment of the plurality of rib segments is less than a height of the plurality of lugs.

3. The drive track of claim 2, wherein the height of each rib segment of the plurality of rib segments is constant.

4. The drive track of claim 2, wherein the height of each rib segment of the plurality of rib segments is variable.

5. (canceled)

6. (canceled)

7. The drive track of claim 1, wherein:
the endless belt has a plurality of windows defined in the longitudinal direction; and
the plurality of rib segments is disposed laterally between at least two windows of the plurality of windows.

8. The drive track of claim 1, wherein the plurality of rib segments is a plurality of plurality of rib segments.

9. The drive track of claim 8, wherein:
the plurality of plurality of rib segments comprises a first plurality of rib segments, a second plurality of rib segments, a third plurality of rib segments, a fourth plurality of rib segments, and a fifth plurality of rib segments.

10. The drive track of claim 9, wherein:
the endless belt has a first and a second lateral side;
the endless belt has a first row of windows and a second row of windows defined in the longitudinal direction;
the first plurality of rib segments is disposed laterally between the first row of windows and the first lateral side;
the second plurality of rib segments is disposed laterally between the first row of windows and the third plurality of rib segments;
the third plurality of rib segments is laterally centered;
the fourth plurality of rib segments is disposed laterally between the second row of windows and the third plurality of rib segments; and
the fifth plurality of rib segments is disposed laterally between the second row of windows and the second lateral side.

11. The drive track of claim 8, further comprising at least one internal band disposed on an inner surface of the endless belt and extending in a longitudinal direction around then entirety of the endless belt; and
wherein the at least one internal band is laterally aligned with at least one plurality of rib segments of the plurality of plurality of rib segments.

12. The drive track of claim 11, wherein a hardness of the plurality of lugs, a hardness of the plurality of plurality of rib segments, and a hardness of the at least one band are less than a hardness of a layer of the endless belt, the layer of the endless belt including the inner surface of the endless belt.

13. The drive track of claim 1, wherein each rib segment of the plurality of rib segments is made from rubber.

14. (canceled)

15. (canceled)

16. The drive track of claim 1, wherein at least one rib segment of the plurality of rib segments passes over at least one stiffening rod of the plurality of stiffening rods.

17. The drive track of claim 1, wherein all longitudinally consecutive rib segments of the plurality of rib segments are connected to each other by the corresponding lug of the plurality of lugs disposed longitudinally between the longitudinally consecutive of rib segments.

18. The drive track of claim 1, wherein the lugs connecting consecutive rib segments define apertures in an end thereof for receiving studs therein.

19. The drive track of claim 1, wherein:
the plurality of rib segments is a first plurality of plurality of rib segments and a second plurality of rib segments;
the endless belt has a first and a second lateral side;
the endless belt has a first row of windows and a second row of windows defined in the longitudinal direction;
the first plurality of rib segments is disposed laterally between the first row of windows and the first lateral side;
the second plurality of rib segments is disposed laterally between the second row of windows and the second lateral side.

20. A vehicle comprising:
a frame;
a motor supported by the frame; and
the drive track according to claim 1 operatively connected to the motor.

21. The vehicle of claim 20, wherein:
the vehicle is a snowmobile;
the frame has a tunnel;
the drive track is disposed at least in part under the tunnel; and
the snowmobile further comprises at least one ski operatively connected to the frame.

22. The vehicle of claim 21, further comprising a rear suspension assembly connected to the frame, the rear suspension assembly including at least one idler wheel; and
wherein the plurality of rib segments is laterally aligned with the at least one idler wheel.

23. The vehicle of claim 22, wherein the drive track further comprises at least one internal band disposed on an inner surface of the endless belt and extending in a longitudinal direction around then entirety of the endless belt;
wherein the at least one internal band is laterally aligned with the at least one idler wheel; and
wherein a width of the at least one internal band is greater than or equal to a width of an outer surface of the at least one idler wheel.

24. The vehicle of claim 21, further comprising a rear suspension assembly connected to the frame, the rear suspension assembly including at least one slide rail; and
wherein the at least one slide rail is disposed laterally between the plurality of rib segments and a lateral center of the endless belt.
